(19) United States
(12) Patent Application Publication
(10) Pub. No.: US 2012/0078422 A1
(43) Pub. Date: Mar. 29, 2012

(54) INTERFACING CLIMATE CONTROLLERS AND COOLING DEVICES

(76) Inventors: Jose M. Mejias, Isabela, PR (US); Victor Davila, Aguadilla, PR (US)

(21) Appl. No.: 13/322,973

(22) PCT Filed: Jul. 29, 2009
(86) PCT No.: PCT/US09/52148

§ 371 Date: Nov. 29, 2011

(51) Int. Cl. G05D 23/00; G05B 15/00

(52) U.S. Cl. 700/277; 700/276

(57) ABSTRACT

A method (400) for cooling includes accessing (410) a preferred temperature corresponding to a computer system, accessing (420) a current feedback temperature signal associated with one of a plurality of cooling devices, determining (430) an actual temperature corresponding to the computer system, comparing (440) the preferred temperature to the actual temperature and generating (450) instructions that modify the current feedback temperature signal associated with the one of the plurality of cooling devices such that the modified current feedback signal instructs the one of the plurality of cooling devices to provide cooling to the computer system such that the actual temperature is proximate the preferred temperature.

### BACKGROUND

Computer system reliability depends on environmental stability. An information technology (IT) facility such as a data center typically includes an environmental control system intended to operate each system within a suitable range of conditions.

Data center managers and customers face a growing challenge managing the cooling and electrical specifications of diverse information technology (IT) equipment deployed in data centers. Some cooling systems provide an optimal data center temperature control by sending temperature and fan speed set points to the cooling devices within the data center. There is no industry standard in terms of physical layers and industrial communication protocols in the Heating, Ventilation and Air Conditioning Industry (HVAC).

### SUMMARY

A method, for cooling includes accessing a preferred temperature corresponding to a computer system, accessing a current feedback temperature signal associated with one of a plurality of cooling devices, determining an actual temperature corresponding to the computer system, comparing the preferred temperature to the actual temperature and generating instructions that modify the current feedback temperature signal associated with the one of the plurality of cooling devices such that the modified current feedback signal instructs the one of the plurality of cooling devices to provide cooling to the computer system such that the actual temperature is proximate the preferred temperature.

### BRIEF DESCRIPTION OF THE DRAWINGS

Embodiments of the invention may best be understood by referring to the following description and accompanying drawings.

FIG. 1A is a schematic block diagram illustrating an embodiment of a system to interface diverse climate controllers and cooling devices in accordance with one embodiment of the present technology.

FIGS. 1B and 1C show an example of address and functions conversion details between Modbus TCP and N2 protocols in accordance with one embodiment of the present technology.

FIG. 2 is a flow diagram of a method for fail safe cooling in accordance with an embodiment of the present technology.

FIG. 3 is a system diagram showing a smart cooling controller adjusting a feedback signal of a computer room air conditioner in accordance with an embodiment of the present technology.

FIG. 4 is a flow diagram of an embodiment of a method for cooling by modifying a feedback signal in accordance with one embodiment of the present technology.

FIG. 5 is a system diagram showing a smart cooling controller adjusting a temperature proximate a feedback sensor of a computer room air conditioner in accordance with an embodiment of the present technology.

FIG. 6 is a flow diagram of an embodiment of a method for cooling by modifying temperature in accordance with one embodiment of the present technology.

FIG. 7 is a system diagram of an exemplary computer system in accordance with an embodiment of the present technology.

### DETAILED DESCRIPTION

Reference will now be made in detail to embodiments of the present technology, examples of which are illustrated in the accompanying drawings. While the technology will be described in conjunction with various embodiment(s), it will be understood that they are not intended to limit the present technology to these embodiments. On the contrary, the present technology is intended to cover alternatives, modifications and equivalents, which may be included within the spirit and scope of the various embodiments as defined by the appended claims.

Furthermore, in the following detailed description, numerous specific details are set forth in order to provide a thorough understanding of the present technology. However, the present technology may be practiced without these specific details. In other instances, well known methods, procedures, components, and circuits have not been described in detail as not to unnecessarily obscure aspects of the present embodiments.

Unless specifically stated otherwise as apparent from the following discussions, it is appreciated that throughout the present detailed description, discussions utilizing terms such as “receiving”, “determining” “enabling”, “accessing”, “identifying”, “associating”, “modifying”, “applying”, “generating”, “initializing,” or the like, refer to the actions and, processes of a computer system, or similar electronic computing device. The computer system or similar electronic computing device manipulates and transforms data represented as physical (electronic) quantities within the computer system's registers and memories into other data similarly represented as physical quantities within the computer system memories or registers or other such information storage, transmission, or display devices. The present technology is also well suited to the use of other computer systems such as, for example, optical and mechanical computers.

Embodiments of the present technology include an industrial rated embedded device consisting of a microprocessor, memory, an Ethernet TCP/IP interface, Serial ports, and several discrete and analog input/output points and temperature sensors. Dynamic Smart Cooling sends temperature and fan speed set points to the device through the Ethernet TCP/IP communication interface using a pre-agreed protocol such as Modbus TCP.

The choices of protocol are user configurable by selecting options within the device configuration. The set points are processed by the device with the purpose of formatting them to the proper temperature feedback signal that the cooling device is expecting. For this purpose, the interface device will require the cooling device configuration of the temperature feedback sensors including the analog standard signal (4-20 ma, 0-10V or 0-5V), scaling information such as the slope and intercept and analog port to be deployed.

In one embodiment, the user provides the fixed temperature set point configured in the particular cooling device plus the error methodology calculation as discussed below. A formatted set point signal is transmitted to the cooling device controller. The cooling device controller uses a closed top loop control system to calculate an error or difference signal that is fed to the controller where a percent of cooling is determined and finally sent to the actuators.

In one embodiment, the present invention receives instructions from a smart cooling device and uses these instructions to generate a signal that makes the CRAC provide the desired cooling. In one embodiment, the present invention generates a signal that the CRAC perceives to be a temperature feedback signal. In this way, the present invention modifies the temperature feedback signal going to a CRAC to achieve a desired cooling from that CRAC.

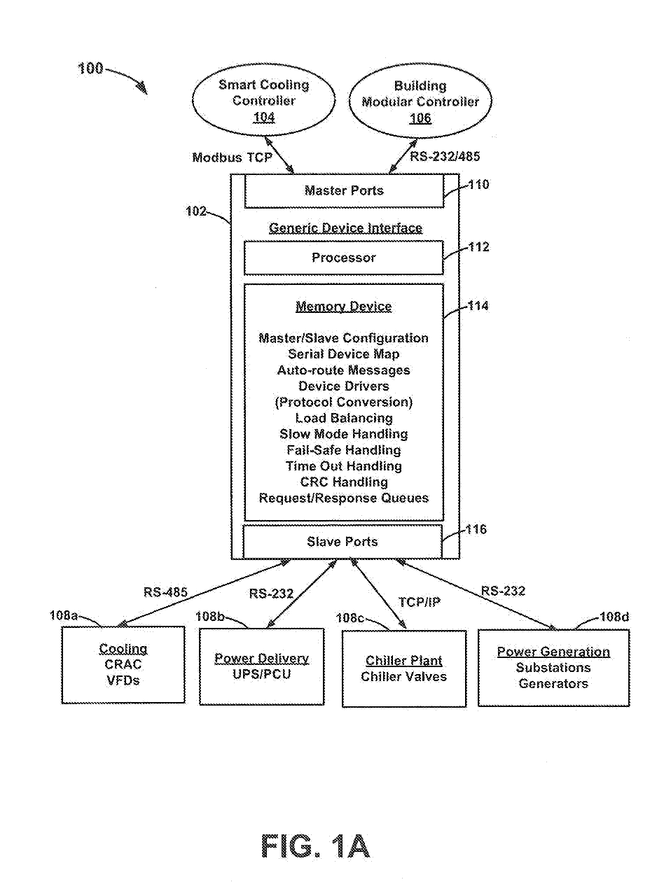

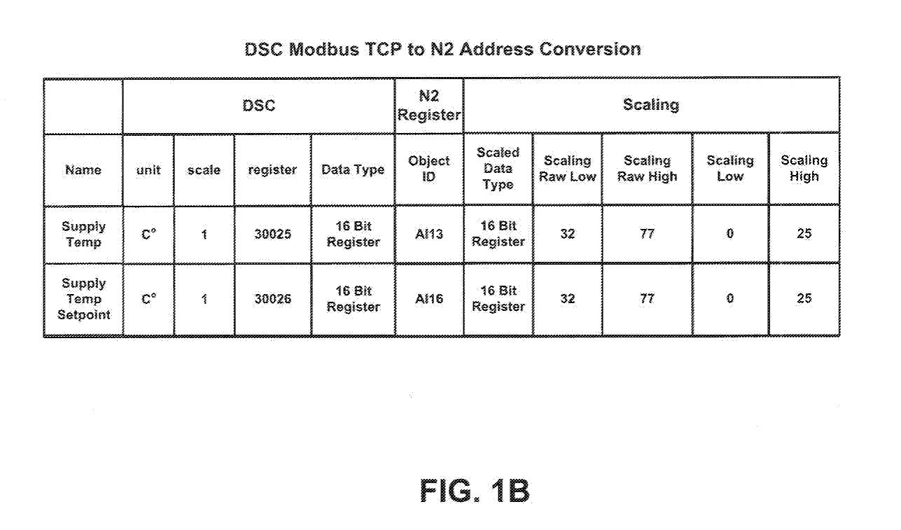

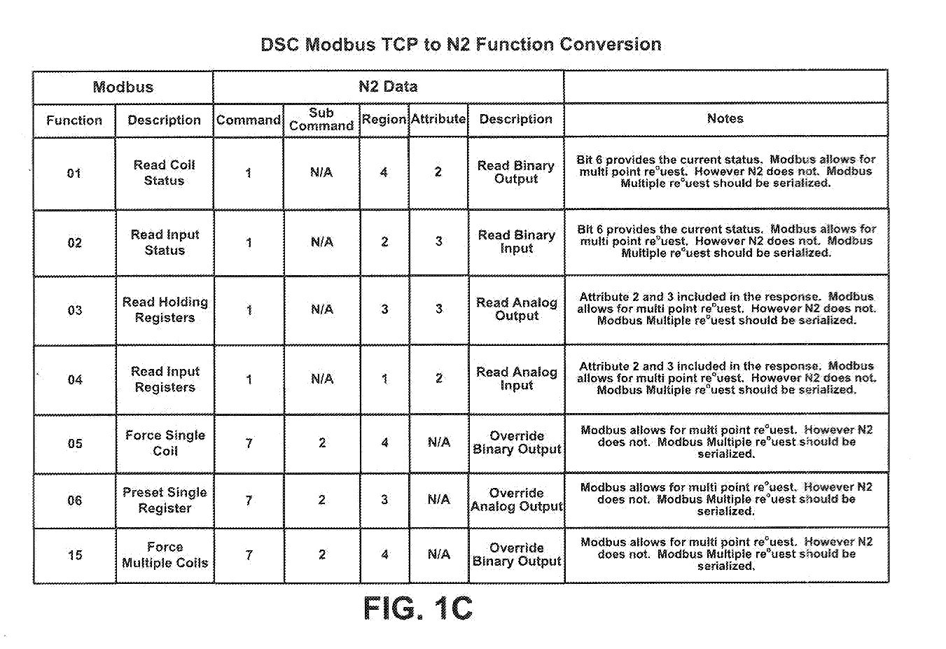

Referring to FIG. 1A, a block diagram illustrating an embodiment of a system 100 is shown including generic device interface (GDI) 102 to translate messages in diverse communication protocols used by climate controllers 104, 106 to messages in communication protocols used by cooling devices 108a-108d (collectively “108”). The embodiment shown includes a smart cooling controller 104 and building modular controller 106. The cooling devices 108 include computer room air conditioning (CRAC) with variable frequency drive (VFD) 108a, uninterruptible power supply and power control unit 108b, chiller plant 108c, and power substations and generators 108d. Other controllers 104, 106, and cooling devices 108 can be used in addition to or instead of those shown. GDI 102 typically includes a computer processor 112, a memory device 114, and multiple master ports 110 and slave ports 116.

GDI 102 allows variables and registers to be defined per cooling device, therefore standardizing the mapping between controllers 104, 106 and cooling devices 108. A specific piece of information such as the Supply Air Temperature (SAT) can be accessed in GDI 102. GDI 102 provides mapping to request this information to a specified cooling device 108. The operational status of GDI 102 can be verified by smart cooling controller 104 and vice versa using a pre-agreed protocol.

GDI 102 sends temperature and fan speed set points from climate controllers 104, 106 to the cooling devices 108 within a data center. Smart cooling controller 104 provides automated thermal and power management techniques based on measurements of total airflow consumption including measurements of airflow derived from fan speed, pressure, and/or direct flow measurements from an anemometer and local ambient temperature information both at the front and rear of the computer server racks. The information can be used to control overall system volume flow produced by computer room air conditioning and to adjust the open area of perforated floor tiles at various suitable locations in the data center, thereby controlling local airflow. Dynamic sensing of airflow and load information in multiple individual locations and for multiple individual heat dissipating elements enables autonomous adjustment of cooling resources based on overall and local system conditions. Automated thermal and power management further can enable energy savings, allowing cooling reduction in low-load conditions while ensuring absolute maximum cooling for high-load operations under feedback control.

Dynamic sensing of airflow enables a data center manager or user to view the amount of air drawn by each individual server and accordingly can be used to facilitate arrangement and configuration of components, devices, and other structures in the data center. For example, airflow sensing may be used to detect overly-constrained signal cabling in a rack that impedes flow through the rack or locations in a room which are starved for air, resulting in a high ambient temperature.

Dynamic airflow sensing may also be used to make policy decisions. For example workload can be monitored for criticality of work that an individual server is performing. A server performing a higher criticality operation may be supplied with a higher airflow while another server performing a less important operation may be supplied with a lower airflow. An example of a smart cooling controller 104 is further described in Malone et al. U.S. patent application Ser. No. 11/046,476 entitled “Thermal And Power Management Apparatus”, which is assigned to the same assignee as the present disclosure and is incorporated by reference herein.

Since there are no standard physical layers or communication protocols in the Heating, Ventilation and Air Conditioning Industry (HVAC), device interface 102 enables smart cooling controller 104 to interface with all the commonly used HVAC protocols and physical layers, and to include back-up fail-safe capability using building modular controller 106.

Processor 112 can be configured to execute logic instructions stored in one or more memory devices 114. Memory device 114 can store data and logic instructions for master/slave configurations, generating a serial device map, auto-routing messages, device drivers that typically implement protocol conversion, load balancing, slow-mode handling, fail-safe handling, time out handling, appending cyclic redundancy check (CRC) information to messages, and storage space for request and response message queues.

In some embodiments, control, status and alarm data is communicated between master ports 110 and controller 104 through an Ethernet TCP/IP interface by using Modbus TCP, while an RS-232 or 485 serial protocol is used to communicate data between controller 106 and master ports 110. GDI 102 can act as a slave device in a Modbus/TCP protocol communication by using the TCP/IP standard protocol. Modbus/TCP commands can be converted to the specified serial communication protocol and routed to the proper serial slave port 116. The protocol conversion can convert device ID, Message type, Message Address, register setting, and other relevant information to the proper protocol over the available physical layers such as RS-422, RS-485, RS-232 and TCP/IP while checking the integrity of the messages. Upon conversion, GDI 102 acts's a serial master sending converted request messages to the slave cooling devices 108.

Table 1 shows an embodiment of a list of parameters that can be used in GDI 102 to configure Modbus/TCP to serial protocol conversion with smart controller 104 or other master device using the Ethernet Modbus/TCP protocol. Table 1 further indicates the source of data for the parameters, such as smart controller 104, the network environment, and GDI 102. Note that similar tables for other serial devices can be included in memory device 114.

TABLE 1
Smart Controller Modbus/TCP to Serial
Protocol Conversion Configuration

| | Smart Controller | |
|---|---|---|
| | Application, | |
| | Environment, | |
| Parameter | Device Dependent | Description |
| Smart Controller | Smart Controller | Smart Controller Modbus |
| Modbus/TCP | | device id. |
| Device Id | | |
| Smart Controller | Smart Controller | Smart Controller Modbus |
| Function Code | | function code for this |
| | | message |
| Smart Controller Start | Smart Controller | Smart Controller Modbus |
| Address | | start address of registers or |
| | | coils |
| Smart Controller | Smart Controller | Smart Controller Modbus |
| Length/Number Coils | | length in words or number |
| | | of coils. Maximum of TBD |
| | | words. |
| Serial Protocol | Environment | Serial protocol designator |
| | | 00 = Modbus/RTU |
| | | 01 = N2 |
| | | 02 = BACnet |
| | | etc |
| Conversion Control | Device Dependent | Conversion Control Flags: |
| | | bit 0 (01) = Register Bit |
| | | Conversion Enable |
| Serial Device Id | Environment | Device Id of serial device |
| | | on the RS-485 network. |
| Serial Function Code | Device Dependent | The serial function code for |
| | | the specified serial protocol |
| | | supported by the device |
| Serial Start Address | Device Dependent | Start address of registers or |
| | | coils |
| Register bit conversion | Device Dependent | Register bit conversions. |
| table | | (This entry is valid if the |
| | | Register Bit Conversion |
| | | Enable Conversion control |
| | | option is set.) |

GDI 102 can include an Ethernet interface to handle Ethernet access as defined by the TCP/IP standard. The protocol layer can be configured to handle various protocols such as Modbus TCP and SNMP, among others.

GDI 102 allows multiple serial and Modbus/TCP masters such as controllers 104, 106 to communicate with slave devices such as cooling devices 108 at the same time by routing request messages from controllers 104, 106 to the proper cooling devices 108 as the communication channel and response time permits. Accordingly, memory device 114 can include a map of the location and communication protocol of the serial devices per network to properly convert and route request and response messages. Details on protocol conversion can be handled by device drivers that include information on how to handle features such as framing, device identification, address conversion, function conversions, data scaling and error check conversion. For example, a smart cooling device (Modbus TCP) to N2 system protocol driver can execute the following process when addressing a particular Modbus TCP request. Note that FIGS. 1B and 1C show an example of address and functions conversion details between Modbus TCP and N2 protocols.
1. Receive Modbus TCP Frame
2. Decode Frame in Binary Mode and identify its contents
   a. Identify and Save Transaction Header (Byte 1 and 2)
   b. Identify and Save Product Identifier (Byte 3 and 4)
   c. Identify and Save Unit Identifier (Byte 7)
   d. Identify and Save Function Code (Byte 8)
   e. Identify and Save DSC Data Address of the first register by adding 30001 to the contents of Byte 9, and 10
   f. Identify and Save the Number of Registers to read (Byte 11 and 12)
3. Modbus TCP registers to read range goes from the first register to read up to (first register to read+number of registers−1).
4. Correlate Modbus TCP register to read with N2 object by using Table 2
5. For as many number of object ID to read, construct the N2 message as follows (using ASCII encoding)
   i. Frame Start (1 character)—Add N2 Frame start character “>” by using ASCII encoding
   ii. Unit Identifier (2 characters)—Retrieve Modbus Unit Identifier and decode it in ASCII mode.
   iii. N2 Data (2 characters)—Use Table 3 to identify the corresponding N2 data by using the requested Modbus Function code.
   iv. N2 Object ID (2 characters)—Append the first object ID
   v. N2 Attribute (2 characters)—Use Table 3 to identify the corresponding N2 attribute by using the requested Modbus Function code.
   vi. Calculate Checksum (2 characters)—The checksum is computed by adding the values of all characters in the frame, excluding the frame start and frame end characters “>”, <CR> respectively. The sum is then divided by 256 and the integer remainder in hex becomes the checksum.
   vii. Frame End (1 Character)—Add N2 frame end character <CR> by using ASCII encoding.
6. Send the frame to the corresponding serial port by using the location map.
7. Wait for a response
8. Decode Response as follows:
   i. Frame response by identifying frame start and frame end characters.
   ii. Verify Response integrity by comparing the frame calculated CRC with frame CRC
   iii. Take bytes 4 to 11, decode them using ASCII and decode in BCD. Use IEEE 754-1985 floating point format to convert to a numerical value. Scale value as required by using Scaling parameters in Table 2. Save value.
9. Go to step 5 if there are more Object IDs to read. If not Go to step 10.
10. Build Modbus TCP Response as follows (Binary Encoding)
   i. Retrieve and Append Transaction Header (2 Bytes)
   ii. Retrieve and Append Protocol Identifier (2 Bytes)
   iii. Calculate Byte Length [3+2*(# of Objects)]
   iv. Retrieve and Append Unit Identifier (1 Byte)
   v. Retrieve and Append Function Code (1 Byte)
   vi. Calculate number of bytes to follow [2*(# of Objects)]
   vii. Append Objects Values (2 Bytes per Object)
11. Send to the TCP/IP Layer

An example of conversions between DSC Modbus TCP to N2 is shown below:

### DSC Modbus TCP Request

| | | | | | | | | | | | | |
|---|---|---|---|---|---|---|---|---|---|---|---|---|
| Hex | F5 | 8F | 00 | 00 | 00 | 06 | 01 | 04 | 00 | 24 | 00 | 02 |

| | | | | | | | |
|---|---|---|---|---|---|---|---|
| Description | Transaction Header | Protocol Identifier | Length | Unit Identifier | Function Code | Data Address of the | Number of Register |
| | | | | | | First Register | To Read |
| Decimal | 62907 | 0 | 11 | 1 | 4 | 24 | 2 |

### N2 Requests

| Hex | 3E | 30 | 31 | 31 | 31 | 31 | 35 | 30 | 32 | 38 | 14 | 0D |
|---|---|---|---|---|---|---|---|---|---|---|---|---|
| Description | Frame | Unit ID | | Command | Region | Object | | Attribute | | Checksum | | Frame |
| | Start | | | | | | | | | | | End |
| ASCII | > | 0 | 1 | 1 | 1 | 1 | 6 | 0 | 2 | 8 | C | <CR> |
| Hex | 3E | 30 | 31 | 31 | 31 | 31 | 33 | 30 | 32 | 38 | 29 | 0D |
| Description | Frame | Unit ID | | Command | Region | Object | | Attribute | | Checksum | | Frame |
| | Start | | | | | | | | | | | End |
| ASCII | > | 0 | 1 | 1 | 1 | 1 | 3 | 0 | 2 | 8 | 9 | <CR> |

### N2 Responses

| Hex | 41 | 30 | 30 | 34 | 32 | 38 | 43 | 30 | 30 | 30 | 30 | 45 | 37 | 0D |
|---|---|---|---|---|---|---|---|---|---|---|---|---|---|---|
| Description | Frame | Object Status | | Object Value | | | | | | | | Checksum | | Frame |
| | Start | | | | | | | | | | | | | End |
| ASCII | A | 0 | 0 | 4 | 2 | 8 | C | 0 | 0 | 0 | 0 | E | 7 | <CR> |
| Hex | 41 | 30 | 30 | 34 | 32 | 34 | 38 | 30 | 30 | 30 | 30 | 45 | 37 | 0D |
| Description | Frame | Object Status | | Object Value | | | | | | | | Checksum | | Frame |
| | Start | | | | | | | | | | | | | End |
| ASCII | A | 0 | 0 | 4 | 2 | 4 | 8 | 0 | 0 | 0 | 0 | F | 2 | <CR> |

### DSC Modbus TCP Response

| | | | | | | | | | | | | | |
|---|---|---|---|---|---|---|---|---|---|---|---|---|---|
| Hex | F5 | 8F | 00 | 00 | 00 | 06 | 01 | 04 | 04 | 00 | 24 | 00 | 02 |

| | | | | | | | | |
|---|---|---|---|---|---|---|---|---|
| Description | Transaction Header | Protocol Identifier | Length | Unit Identifier | Funcoon Code | Number of | Data Register for | Data Register for |
| | | | | | | Data | 30025 | 30026 |
| | | | | | | Bytes to | | |
| | | | | | | Follow | | |
| Decimal | 62907 | 0 | 11 | 1 | 0 | 4 | 21 | 10 |

GDI 102 can generate a devices location map by broadcasting requests to all available serial ports. It records the request responding serial port and unit identifier to construct a location map. The process is dynamic in nature, looking for lost devices whenever a response is not received in a given amount of time.

Additionally, memory device 114 can include information required to configure master ports 110 and slave ports 116, as required. Table 2 shows an example of parameters that can be used to configure serial master ports 110 and slave ports 116.

TABLE 2
Serial Port Configuration Parameters

| Parameter | Description |
|---|---|
| Baud Rate | Baud rate of serial port. |
| Interface Mode | Interface mode of serial port. |
| | 0 = RS-232 (Default) |
| | 1 = RS-422 |
| | 2 = RS-485 |
| Parity | Serial port parity setting. |
| | 0 = None (Default) |
| | 1 = Even |
| | 2 = Odd |
| Data Bits | Number of serial port data bits. Valid Values: 5-8 |
| | (Default = 8) |
| Stop Bits | Number of serial port stop bits. |
| | Valid Values: 1 or 2 |
| | (Default = 1) |
| Flow Control | Flow control setting. |
| | 0 = None (Default) |
| | 1 = RTS/CTS |
| | 2 = XON/XOFF |
| | 3 = Half Duplex |
| DTR Control | DTR settings. |
| | 0 = Off (Default) |
| | 1 = On |
| Receive Time Between | Receive time between packets. Timeout if |
| Packets | incomplete message is received. 0 to 65535 msec |
| | (Default = 100) |
| Serial Port Protocol | Serial Port Protocol Mode |
| | 0 = None |
| | 1 = Serial Port Master - |
| | 2 = Serial Port Slave |
| Serial Port Control | Serial Port Control Flags |
| Flags | Bit 0 (0001 Hex) = Reserved |
| | Bit 1 (0002 Hex) = Enable Discard Rx Packets |
| | With Errors |
| | Bit 2 (0004 Hex) = Reserved |
| | Bit 3 (0008 Hex) = Reserved |
| | Bit 4 (0010 Hex) = Enable Lost Search Device |
| | Enable |
| | Bit 5 (0020 Hex) = Reserved |
| | Bit 6 (0040 Hex) = Reserved |
| | Bit 7 (0080 Hex) = Reserved |
| | Bit 8 (0100 Hex) = Reserved |
| | Bit 9 (0200 Hex) = Enable Multi-Master Load |
| | Balancing |
| | Bit 10 (0400 Hex) = Enable Slow Device Mode |
| | Bit 11 (0800 Hex) = Perform Multi-Master Load |
| | Balancing based on Modbus/TCP connection. |
| Slave Device | The timeout period in which a slave device must |
| Response Timeout | respond before it is considered timed out. |
| Slow Device Mode Rx | Specifies how old a previously received |
| Message Age Time | response can be used as a valid response |
| | message. |
| Slow Device Mode | Specifies how many retries are allowed before a |
| TX Retries | write or Fail-Safe message is considered timed |
| | out. |

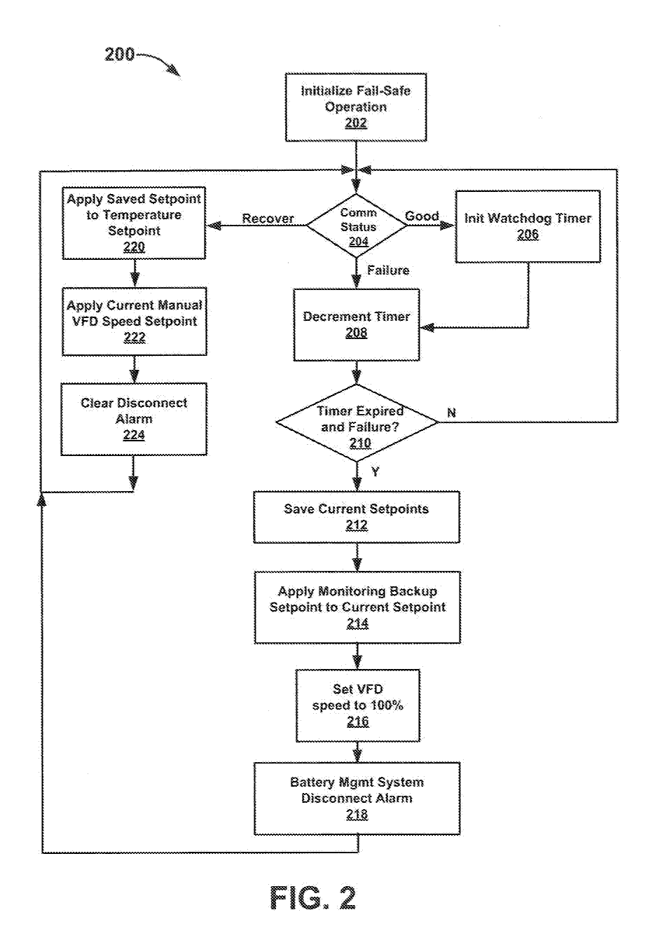

Referring to FIGS. 1 and 2, FIG. 2 shows a flow diagram of an embodiment of a fail-safe process 200. GDI 102 can detect the absence of smart cooling controller 104 by either counting the time between any request directed to the cooling devices or a particular register write request configured within GDI 102. For either case, a threshold time is configured, that if exceeded, triggers the mitigation actions. The mitigation actions can include saving the cooling device's current operation set points and writing safe operation set points to pre-configured registers that are read and used by a fail-safe controller, such as controller 106.

Process 202 can include initializing parameters for fail-safe operation. For example, GDI 102 can provide configuration interfaces for the user to select registers that contain current set point parameters for each cooling device 108. The interface may also allow the user to select the functions to properly read and write the set points. GDI 102 can include determining whether the specified functions successfully read/write the registers to help insure that fail-safe mode operates correctly. GDI 102 can also retry reading/writing the fail-safe registers in the event of read errors. A number of allowable retries can be specified before an alert is issued to the user.

Process 204 can include determining the communication status with smart controller 104. For example, whenever a preferred or primary controller, such as smart controller 104 stops sending data to GDI 102 for a preconfigured period of time, the fail-safe mode can be triggered to allow controller 106 to take over cooling control. This functionality can be configured for one, many, or all the controllers 104, 106.

If the communication status is good, process 206 initializes the watchdog timer to a predetermined Value, for example 5 minutes. Process 208 can be performed on transition from process 206 or if process 204 determines there is a communication failure between GDI 102 and smart controller 104. Process 208 can include decrementing the timer, and transitioning to process 210 to determine whether the timer has expired and there is a communication failure. GDI 102 can expose a set of configurable registers set for watchdog timer register where the controllers 104, 106 can write periodically to indicate the operational status of the controllers 104, 106. GDI 102 can also use an assigned register to which controllers 104, 106 can refer to determine the operational status of GDI 102.

If the timer has expired and a communication failure has been detected, processes 212-218 can be performed. Process 212 can include saving the current temperature set points being used by smart controller 104. Process 214 can include setting backup temperature set points to be used by controller 106 to the current temperature set points being used by smart controller 104. Process 216 can include setting the variable frequency drive (VFD) fan speeds to regulate the cooling devices 108. In some implementations, the fan speeds can be set to full (100%) for fail-safe mode. Other appropriate settings can be used, however. Process 218 can include raising a communication disconnect alarm in a battery management system so that backup power is available to system 100 and an operator is alerted that backup power has been activated. Process 218 can also indicate the number of devices 108 operating in fail-safe mode. Process 218 transitions to process 204 to once again determine communication status.

Referring again to process 204, process 204 can include determining whether GD1 102 is recovering from a communication failure with smart controller 104. If so, process 220 applies the set points saved in process 212 to the current set points. Process 222 can include applying the current VFD fan speeds, and process 224 can include clearing the disconnect alarm. GDI 102 can deactivate the alarm by clearing the number of devices 108 in fail-safe mode.

### Cooling by Modifying a Temperature Feedback Signal without Requiring Protocols

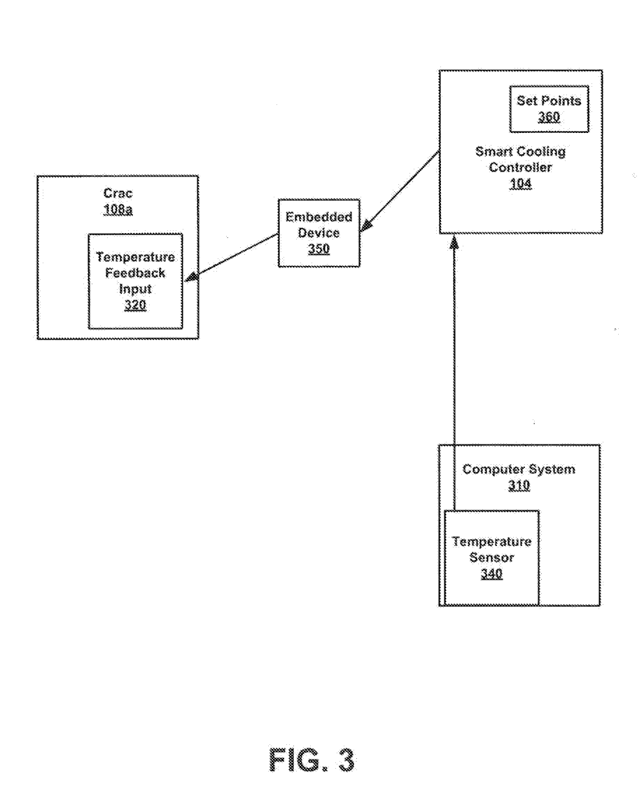

FIG. 3 is a system diagram showing a smart cooling controller 104 adjusting a feedback signal of a computer room air conditioner 108a in accordance with an embodiment of the present technology. It is appreciated that this embodiment is different from the embodiment described above in that the present invention does not require the use of protocols, as described above.

In one embodiment, CRAG 108a is one of a plurality of CRACs responsible for controlling the temperature surrounding computer system 310. CRAG 108a includes a temperature feedback input 320. From the factory, the temperature feedback 320 is designed to receive a signal indicating the actual temperature of the air returning to the CRAC 108a.

However, in accordance with the present technology, the smart cooling device 104 intercepts the feedback signal and may modify that signal to control the operation of the CRAG 108a. The set points 360 are processed by the smart cooling device 104 with the purpose of determining if cooling is needed or not and providing that decision to the embedded device 350. If cooling is needed, the embedded device 350 generates the proper temperature feedback signal 320 that will instruct the cooling device 108a to provide the desired cooling. For this purpose, in one embodiment, the embedded device 350 provides a temperature feedback signal that is an analog standard signal (4-20 ma, 0-10V or 0-5V).

For example, in one embodiment, the smart cooling device 104 knows a temperature set point 360 associated with computer system 310. A temperature sensor 340 proximate the computer system 310 provides the actual temperature of the computer system 340 to the smart cooling device 104. Based on the set point 360 and based on the actual temperature of the computer system 310, the smart cooling device provides a signal to the embedded device 350 that can be used to generate a feedback signal that is used to control the CRAG 108a.

In this embodiment, the feedback signal received by the CRAG 108a is not associated with the air return temperature but is associated with the cooling decision made by the smart cooling device 104. The embedded device 350 generates a signal that the CRAC 108a assumes to be the temperature feedback signal and can understand.

The embedded device 350 is also capable of interfacing with support peripherals such as Variable Frequency Devices (VFD) by using analog standard signals. For example, cooling device fan speed might be controlled by a VFD and commanded by the embedded device 350. The functionality is very similar to the cooling devices cases where the interface device receives a signal, converts it to a proper format analog signal and sends them to the VFD that commands the fan speed to the proper set point.

The embedded device 350 is also capable of receiving cooling or supporting devices alarms in the form of analog signals. These devices typically implement a generic alarm as an analog output that can be read by the smart cooling device 108a.

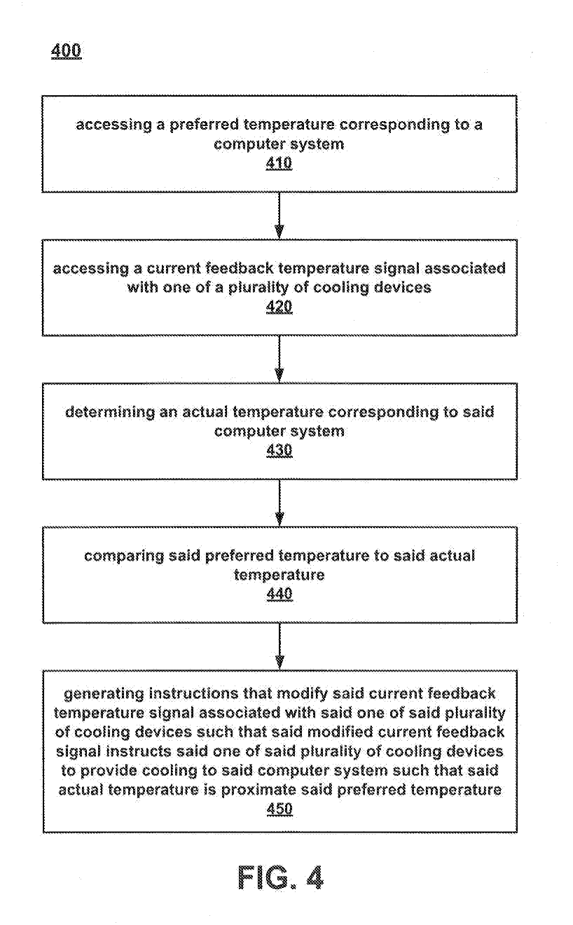

FIG. 4 is a flow diagram of an embodiment of a method 400 for cooling by modifying a feedback signal in accordance with one embodiment of the present technology.

At 410, 400 includes accessing a preferred temperature corresponding to a computer system.

At 420, 400 includes accessing a current feedback temperature signal associated with one of a plurality of cooling devices.

At 430, 400 includes determining an actual temperature corresponding to the computer system. In one embodiment, a temperature sensor proximate the computer system provides the actual temperature of the computer system. In another embodiment, the operating system of the computer provides the temperature information. In one embodiment, the actual temperature is determined from a digital signal.

At 440, 400 includes comparing the preferred temperature to the actual temperature determined in 430.

At 460, 400 includes generating instructions that modify the current feedback temperature signal associated with the one of the plurality of cooling devices such that the modified current feedback signal instructs the one of the plurality of cooling devices to provide cooling to the computer system such that the actual temperature is proximate the preferred temperature. In one embodiment, the temperature feedback signal is formatted to include an analog standard signal (4-20 ma, 0-10V or 0-5V).

### Cooling by Modifying a Temperature Around a Temperature Feedback Sensor

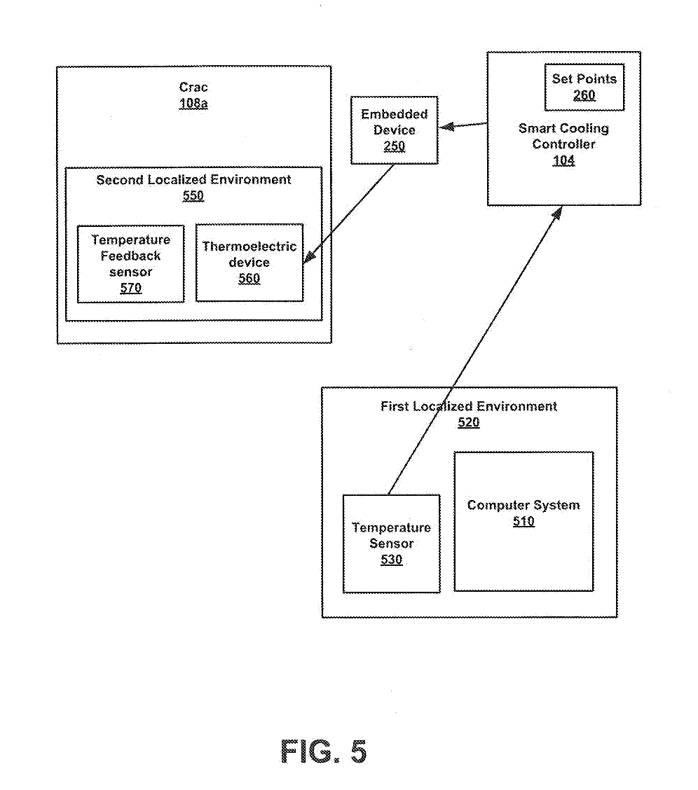

FIG. 5 is a system diagram showing an embedded device 350 adjusting a physical temperature proximate a feedback sensor 570 of a computer room air conditioner 108a in accordance with an embodiment of the present technology.

In the embodiment above, the feedback signal is modified to control cooling. In this embodiment, the temperature around the temperature sensor coupled to the cooling device 108a is modified to control cooling.

In one embodiment, a first localized environment 520 is associated with a computer system 510 and a temperature sensor 530. The actual temperature of the first localized environment 520 is compared to a set point 260. In response to determining a difference between the actual temperature and the set point, the smart cooling device instructs the embedded device 350 to modify the actual temperature of a second localized environment to change cooling in the first localized environment.

In one embodiment, the embedded device 350 controls a thermoelectric element 560 in the second localized environment to increase or decrease the actual temperature in the second localized environment. The temperature feedback sensor 570 of the cooling device 108a recognizes the change in temperature and responds accordingly to provide the desired cooling.

The cooling device 108a utilizes its own temperature feedback sensor 570. The embedded device 350 will provide just enough power to a thermoelectric device 560 to hold the temperature of the second localized environment 550 at a desired temperature. Whenever the temperature of the second localized environment 550 increases, the temperature sensor 570 detects this change and in response, the cooling device provides extra cooling power to the computer system to keep the thermal load at the set point.

For example, if the actual temperature in the first localized environment is higher than the set point, the embedded device will use the thermoelectric device 560 to heat the second localized environment around the sensor 570 to initiate the cooling device 108a to cool the first localized environment. If the actual temperature in the first localized environment is lower than the set point, the embedded device will control the thermoelectric device 560 to cool the second localized environment around the sensor 570 to stop the cooling device 108a from cooling the first localized environment.

In one embodiment, thermoelectric device 560 is a Peltier effect element. This element is capable of providing cooling by applying voltage to its terminals. Thermoelectric heating is also possible by reversing the polarity of the applied voltage. Solid-state relays, discrete and analog signal are properly deployed to achieve this functionality within the cooling device 108a. In one embodiment, the embedded device 350 is capable of controlling the cooling device to maintain temperature to well within 0.1° C. in the first localized environment 520.

In one embodiment, the embedded device 350 implements a 1—wire bus system temperature sensor (not shown) to measure the temperature near the cooling device feedback sensor 570 and therefore supports a closed-loop controller. It is also capable of implementing additional sensors measuring temperature and humidity in various locations within the cooling device 108a. Cooling or heating is not an instantaneous process. In this sense the embedded device 350 provides time constants significantly higher in comparison to the cooling devices time constant to be able to provide the functionality desired.

Cooling devices powered by compressor or chilled water technologies deployed in typical data centers process a very slow time constant due to their higher thermal damping nature. Many factors need to be considered to determine the actual time-constants since it depends on many factors external to our implementation. However, due to the localized nature of the device interface closed-loop controller, the slow time constants of data center thermal environment and the thermo-electric element time constant (0.5° C./Second), the present technology is capable of providing suitable cooling or heating ramp rates to perform the job required.

This embodiment of the present technology does not involve communication protocols, does not require modification of the location of the feedback temperature sensors and does not require modification to the cooling devices firmware to make it compatible with DSC. Moreover, this embodiment opens market opportunities for DSC since it permits interfacing with cooling devices that support analog signals feedback temperature ports that account for almost 80% of the market.

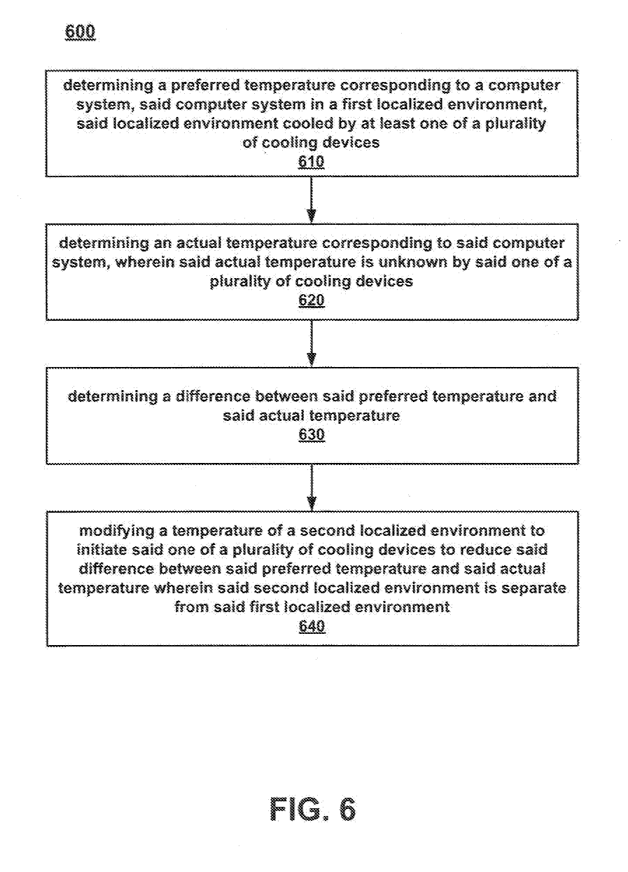

FIG. 6 is a flow diagram of an embodiment of a method 600 for cooling by modifying temperature in accordance with one embodiment of the present technology.

At 610, 600 includes determining a preferred, temperature corresponding to a computer system, the computer system in a first localized environment, the first localized environment cooled by at least one of a plurality of cooling devices.

At 620, 600 includes determining an actual temperature corresponding to the computer system, wherein the actual temperature is unknown by the one of a plurality of cooling devices.

At 630, 600 includes determining a difference between the preferred temperature and the actual temperature.

At 640, 600 includes modifying a temperature of a second localized environment to initiate the one of a plurality of cooling devices to reduce the difference between the preferred temperature and the actual temperature wherein the second localized environment is separate from the first localized environment.

### Example Computer System Environment

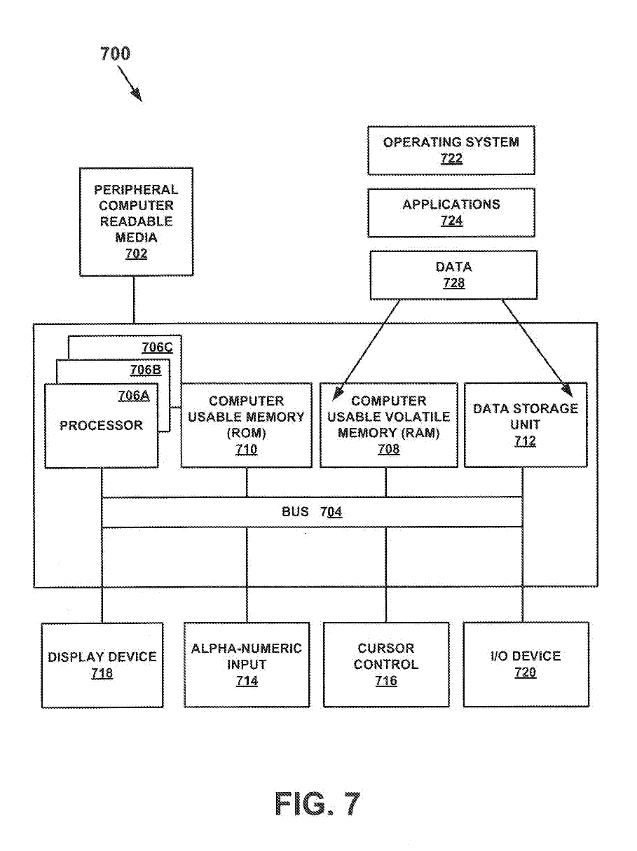

With reference now to FIG. 7, portions of the technology for cooling are composed of computer-readable and computer-executable instructions that reside, for example, in computer-usable storage media of a computer system. That is, FIG. 7 illustrates one example of a type of computer that can be used to implement embodiments, which are discussed below, of the present technology.

FIG. 7 illustrates an example computer system 700 used in accordance with embodiments of the present technology. It is appreciated that system 700 of FIG. 7 is an example only and that the present technology can operate on or within a number of different computer systems, including blade servers, general purpose networked computer systems, embedded computer systems, routers, switches, server devices, user devices, various intermediate devices/artifacts, stand alone computer systems, mobile phones, personal data assistants, and the like. It is also appreciated that system 700 may be one of a plurality of like systems that can be combined and partitioned in accordance with embodiments of the present technology. In one embodiment, system 700 is a single blade computer system of a multi-blade server system. However, in another embodiment, system 700 is a multi-blade computer server system.

As shown in FIG. 7, computer system 700 of FIG. 7 is well adapted to having peripheral computer readable media 702 such as, for example, a floppy disk, a compact disc, and the like coupled thereto.

System 700 of FIG. 7 includes an address/data bus 704 for communicating information, and a processor 706A coupled to bus 704 for processing information and instructions. As depicted in FIG. 7, system 700 is also well suited to a multi-processor environment in which a plurality of processors 706A, 706B, and 706C are present. Conversely, system 700 is also well suited to having a single processor such as, for example, processor 706A. Processors 706A, 706B, and 706C may be any of various types of microprocessors. System 700 also includes data storage features such as a computer usable volatile memory 708, e.g. random access memory (RAM), coupled to bus 704 for storing information and instructions for processors 706A, 706B, and 706C.

System 700 also includes computer usable non-volatile memory 710, e.g. read only memory (ROM), coupled to bus 704 for storing static information and instructions for processors 706A, 706B, and 706C. Also present in system 700 is a data storage unit 712 (e.g., a magnetic or optical disk and disk drive) coupled to bus 704 for storing information and instructions. System 700 also includes an optional alpha-numeric input device 714 including alphanumeric and function keys coupled to bus 704 for communicating information and command selections to processor 706A or processors 706A, 7066, and 706C. System 700 also includes an optional cursor control device 716 coupled to bus 704 for communicating user input information and command selections to processor 706A or processors 706A, 706B, and 706C. System 700 of the present embodiment also includes an optional display device 718 coupled to bus 704 for displaying information.

Referring still to FIG. 7, optional display device 718 may be a liquid crystal device, cathode ray tube, plasma display device or other display device suitable for creating graphic images and alpha-numeric characters recognizable to a user. Optional cursor control device 716 allows the computer user to dynamically signal the movement of a visible symbol (cursor) on a display screen of display device 718. Many implementations of cursor control device 716 are known in the art including a trackball, mouse, touch pad, joystick or special keys on alpha-numeric input device 714 capable of signaling movement of a given direction or manner of displacement. Alternatively, it will be appreciated that a cursor can be directed and/or activated via input from alpha-numeric input device 714 using special keys and key sequence commands.

System 700 is also well suited to having a cursor directed by other means such as, for example, voice commands. System 700 also includes an I/O device 720 for coupling system 700 with external entities. For example, in one embodiment, I/O device 720 is a network device for enabling wired or wireless communications between system 700 and an external network such as, but not limited to, the Internet.

Referring still to FIG. 7, various other components are depicted for system 700. Specifically, when present, an operating system 722, applications 724, and data 728 are shown as typically residing in one or some combination of computer usable volatile memory 708, e.g. random access memory (RAM), and data storage unit 712. However, it is appreciated that in some embodiments, operating system 722 may be stored in other locations such as on a network or on a flash drive; and that further, operating system 722 may be accessed from a remote location via, for example, a coupling to the internet. In one embodiment, the present technology is stored as BIOS/System Firmware in memory locations within RAM 708 and memory areas ROM 710.

The computing system 700 is only one example of a suitable computing environment and is not intended to suggest any limitation as to the scope of use or functionality of the present technology. Neither should the computing environment 700 be interpreted as having any dependency or requirement relating to any one or combination of components illustrated in the example computing system 700.

The present technology may be described in the general context of computer-executable instructions, such as program Modules, being executed by a computer. Generally, program modules include routines, programs, objects, components, data structures, etc., that perform particular tasks or implement particular abstract data types. The present technology may also be practiced in distributed computing environments where tasks are performed by remote processing devices that are linked through a communications network. In a distributed computing environment, program modules may be located in both local and remote computer-storage media including memory-storage devices.

Although the subject matter has been described in a language specific to structural features and/or methodological acts, it is to be understood that the subject matter defined in the appended claims is not necessarily limited to the specific features or acts described above. Rather, the specific features and acts described above are disclosed as example forms of implementing the claims.

The various functions, processes, methods, and operations performed or executed by the system can be implemented as programs that are executable on various types of processors, controllers, central processing units, microprocessors, digital signal processors, state machines, programmable logic arrays, and the like or any combination thereof. The programs can be stored on any computer-readable storage medium for use by or in connection with any computer-related system or method. A computer-readable, medium is an electronic, magnetic, optical, or other physical device or means that can contain or store a computer program for use by or in connection with a computer-related system, method, process, or procedure. Programs and logic instructions can be embodied in a computer-readable medium for use by or in connection with an instruction execution system, device, component, element, or apparatus, such as a system based on a computer or processor, or other system that can fetch instructions from an instruction memory or storage of any appropriate type.

The illustrative block diagrams and flow charts depict process steps or blocks that may represent modules, segments, or portions of code that include one or more executable instructions for implementing specific logical functions or steps in the process. Although the particular examples illustrate specific process steps or acts, many alternative implementations are possible and commonly made by simple design choice. Acts and steps may be executed in different order from the specific description herein, based on considerations of function, purpose, and conformance to standard, legacy structure, and the like.

While the present disclosure describes various embodiments, these embodiments are to be understood as illustrative and do not limit the claim scope. Many variations, modifications, additions and improvements of the described embodiments are possible. For example, those having ordinary skill in the art will readily implement the steps necessary to provide the structures and methods disclosed herein, and will understand that the process parameters, materials, and dimensions are given by way of example only. The parameters, materials, and dimensions can be varied to achieve the desired structure as well as modifications, which are within the scope of the claims. Variations and modifications of the embodiments disclosed herein may also be made while remaining within the scope of the following claims. The illustrative techniques may be used with any suitable data center configuration and with any suitable servers, computers, and devices.

What is claimed is:

1. A method (400) for cooling comprising:
accessing (410) a preferred temperature corresponding to a computer system;
accessing (420) a current feedback temperature signal associated with one of a plurality of cooling devices;
determining (430) an actual temperature corresponding to said computer system;
comparing (440) said preferred temperature to said actual temperature;
generating (450) instructions that modify said current feedback temperature signal associated with said one of said plurality of cooling devices such that said modified current feedback signal instructs said one of said plurality of cooling devices to provide cooling to said computer system such that said actual temperature is proximate said preferred temperature.

2. The method (400) of claim 1 further comprising:
accessing a second current feedback temperature signal associated with a second of said plurality of cooling devices;
generating instructions that modify said second current feedback temperature signal associated with said second of said plurality of cooling devices such that said modified second current feedback signal instructs said second of said plurality of cooling devices to provide cooling to said computer system such that said actual temperature is proximate said preferred temperature.

3. The method (400) of claim 1 further comprising:
generating (450) instructions that modify said current feedback temperature signal to a higher temperature than said current feedback temperature signal to initiate cooling at said one of said plurality of cooling devices.

4. The method (400) of claim 1 further comprising:
generating (450) instructions that modify said current feedback temperature signal to a lower temperature than said current feedback temperature signal to terminate cooling at said one of said plurality of cooling devices.

5. The method (400) of claim 1 further comprising:
accessing (410) said preferred temperature corresponding to said computer system from a dynamic smart cooling system.

6. The method (400) of claim 1 wherein said actual temperature corresponding to said computer system is accessed (430) in a digital format.

7. The method (400) of claim 6 wherein said instructions are generated (450) as an analog signal.

8. A computer readable storage medium (710) comprising instructions that when executed cause a computer (700) perform a method (400) for cooling, said method (400) comprising:
accessing (410) a preferred temperature corresponding to a computer system;
accessing (420) a current feedback temperature signal associated with one of a plurality of cooling devices;
determining (430) an actual temperature corresponding to said computer system;
comparing (440) said preferred temperature to said actual temperature;
generating (450) instructions that modify said current feedback temperature signal associated with said one of said plurality of cooling devices such that said modified current feedback signal instructs said one of said plurality of cooling devices to provide cooling to said computer system such that said actual temperature is proximate said preferred temperature.

9. The computer readable storage medium (710) of claim 8 wherein said method (400) further comprises:
accessing a second current feedback temperature signal associated with a second of said plurality of cooling devices;
generating instructions that modify said second current feedback temperature signal associated with said second of said plurality of cooling devices such that said modified second current feedback signal instructs said second of said plurality of cooling devices to provide cooling to said computer system such that said actual temperature is proximate said preferred temperature.

10. The computer readable storage medium (710) of claim 8 wherein said method (400) further comprises:
generating (450) instructions that modify said current feedback temperature signal to a higher temperature than said current feedback temperature signal to initiate cooling at said one of said plurality of cooling devices.

11. The computer readable storage medium (710) of claim 8 wherein said method (400) further comprises:
generating (450) instructions that modify said current feedback temperature signal to a lower temperature than said current feedback temperature signal to terminate cooling at said one of said plurality of cooling devices.

12. The computer readable storage medium (710) of claim 8 wherein said method (400) further comprises:
accessing (410) said preferred temperature corresponding to said computer system from a dynamic smart cooling system.

13. The computer readable storage medium (710) of claim 8 wherein said actual temperature corresponding to said computer system is determined (430) in a digital format.

14. The computer readable storage medium (710) of claim 13 wherein said instructions are generated (450) as an analog signal.

15. A method (600) for managing temperature comprising:
determining (610) a preferred temperature corresponding to a computer system, said computer system in a first localized environment, said first localized environment cooled by, at least one of a plurality of cooling devices;
determining (620) an actual temperature corresponding to said computer system, wherein said actual temperature is unknown by said one of a plurality of cooling devices;
determining (630) a difference between said preferred temperature and said actual temperature; and
modifying (640) a temperature of a second localized environment to initiate said one of a plurality of cooling devices to reduce said difference between said preferred temperature and said actual temperature wherein said second localized environment is separate from said first localized environment.

16. The method (600) of claim 15 wherein said second localized environment contains a temperature sensor coupled to said one of a plurality of cooling devices.

17. The method (600) of claim 16 wherein said temperature sensor is a temperature feedback sensor of said one of a plurality of cooling devices.

18. The method (600) of claim 15 further comprising:
heating (640) said second localized environment to initiate cooling to said first localized environment.

19. The method (600) of claim 15 further comprising:
cooling (640) said second localized environment to stop cooling to said first localized environment.

20. The method (600) of claim 15 further comprising:
applying (640) a current to a thermoelectric device located within said second localized environment to cool said second localized environment.

21. The method (600) of claim 15 further comprising:
applying (640) a current to a thermoelectric device located within said second localized environment to heat said second localized environment.
